(19) United States
(12) Patent Application Publication
(10) Pub. No.: US 2004/0151630 A1
(43) Pub. Date: Aug. 5, 2004

(54) Total nitrogen and sulphur analysis using a catalytic combustion gas converter system

(76) Inventors: Herbert A. Hernandez JR., Spring, TX (US); Norbert W. Lenk, Ilmenau (DE)

Correspondence Address: AKIN, GUMP, STRAUSS, HAUER & FELD, 711 LOUISIANA STREET, SUITE 1900 SOUTH, HOUSTON, TX, 77002, US

(21) Appl. No.: 10/648,818

(22) Filed: Aug. 26, 2003

Related U.S. Application Data
(60) Provisional application No. 60/405,918, filed on Aug. 26, 2002.

(51) Int. Cl. G01N 21/76

(52) U.S. Cl. 422/80; 422/52

(57) ABSTRACT

For analysis of total nitrogen, sulfur and/or chlorine, a solid, liquid or gas sample is combusted with oxygen in a high-temperature furnace to form a combustion gas which is then dried and passed over a heated graphite catalyst and thereafter passed through an electrochemical detector for each element to be measured, the detectors being arranged either in parallel or in series with either arrangement providing an individual determination of the content of the element in the sample. A control system provides a user interface for manipulating and controlling the introduction of the sample to the furnace and the operation of the furnace, dryer and electrochemical detector, and the system stores, records and displays data.

### CROSS-REFERENCE TO RELATED APPLICATIONS

N/A

### STATEMENTS REGARDING FEDERALLY SPONSORED RESEARCH OR DEVELOPMENT

N/A

### REFERENCE TO A MICROFICHE APPENDIX

N/A

### BACKGROUND OF THE INVENTION

1. Field of the Invention

The present invention relates to an improvement to an apparatus and method for determination of total nitrogen and/or sulfur content in aqueous and hydrocarbon matrices by oxidizing a sample by combustion and detecting specific chemical compounds using an electrochemical detector.

2. Description of the Related Art

In the field of industrial process measurements, particularly in refinery and chemical stream and waste analysis, one type of analyzer employed frequently for measuring sulfur and nitrogen content incorporates fluorescence and chemiluminescence detectors, respectively. For example, in U.S. Pat. No. 5,152,963 dated Oct. 6, 1992, which is incorporated by reference for all purposes, a total sulfur analyzer system is set forth that operates on gas, liquid or solid samples including free sulfur and sulfur and nitrogen compounds. The sample is first combusted to provide products of combustion including sulfur dioxide (SO₂) and nitric oxide (NO). The SO₂ quantity is measured by exposure to a particular frequency of ultraviolet light to obtain fluorescence, and fluorescent photons are measured by a photomultiplier tube. The NO is reacted with ozone to form NO₂, and in this reaction chemiluminescent light is emitted and measured.

An analyzer using fluorescence and chemiluminescence detectors requires a number of components such as an ultraviolet light source and associated optics, photomultiplier tubes and an ozone generator. These various components are each a potential source of error in a measurement, and some components are sensitive, delicate or fragile as well as expensive. Consequently, a need was felt for a better laboratory or field analyzer capable of measuring total nitrogen, sulfur and/or chlorine. Commonly owned U.S. patent application Ser. No. 09/488,011 which in turn is a continuation-in-part of U.S. patent application Ser. No. 08/823,887, filed Mar. 17, 1997, describes a sample analyzer which in major part fulfills this need while having a superior detection limit for total nitrogen and/or sulfur detection than an analyzer using fluorescence and chemiluminescence detectors.

U.S. patent application Ser. No. 09/488,011 which is incorporated by reference for all purposes, describes an oxidative combustion/electrochemical detection (OCECD) method that was introduced onto the market in 1997 as a direct competitor to the existing combustion/UV fluorescence and the combustion/microcoulometric methods. At that time, these two commonly used methods had been in existence for more than 10 years and each had its advantages and disadvantages. The emergence of the OCECD technique addressed and eliminated most of the negative aspects of the existing methods and provided analysts with a more sensitive yet simple, reliable, precise, and accurate method of sulfur analysis in hydrocarbon liquids. Since introduction of OCECD it has been reported that unspecified, but large, amounts of chemically-bound nitrogen in hydrocarbon liquids may interfere with the determination of total sulfur content by the oxidative combustion/electrochemical detection method (OCECD).

### BRIEF SUMMARY OF THE INVENTION

The present invention provides an improved OCECD analyzer system and a method for measuring total nitrogen, sulfur and/or chlorine in a solid, liquid or gaseous sample. The sample is fed to a furnace module where it is burned in the presence of excess oxygen to produce a combustion gas. Essentially all nitrogen in the sample, except diatomic nitrogen (N₂), is initially converted to nitric oxide (NO). Essentially all sulfur in the sample is initially converted to sulfur dioxide (SO₂), and essentially all chlorine in the sample is converted to hydrogen chloride (HCl). Water is typically in the combustion gas and is preferably removed in a dryer. To ensure that the original composition of the oxidation products produced in the combustion furnace are maintained for later acturate measurement by an electrochemical detector, a catalytic combustion gas converter system is installed between the drying system and the electrochemical detector system to convert any NO₂ and/or NOₓ to NO and any SO₃ to SO₂. Dry combustion gas from the catalytic combustion gas converter system is fed to an electrochemical detector, one detector for each specific compound to be measured. A control system provides a user interface for monitoring and controlling several components such as the furnace module, the temperature of the catalytic combustion gas converter system and the detector.

### BRIEF DESCRIPTION OF THE SEVERAL VIEWS OF THE DRAWINGS

A better understanding of the present invention can be obtained when the following detailed description of various embodiments of the invention is considered in conjunction with the drawings, which are described as follows.

FIG. 1 is a schematic diagram of an improved analytical system having a catalytic combustion gas converter system according to the present invention.

FIG. 2 is a response curve for the determination from a sample of methanol of total nitrogen and sulfur obtained with an OCECD analytical system which is contaminated with carbon residue, with and without the catalytic combustion gas converter being active.

FIG. 3 is a response curve for the determination from a sample of water of total nitrogen and sulfur obtained with an OCECD analytical system which is contaminated with carbon residue with the catalytic combustion gas converter being inactive.

FIG. 4 is a response curve for the determination from a sample of water of total nitrogen and sulfur obtained with an OCECD analytical system which is contaminated with carbon residue with the catalytic combustion gas converter being active.

FIG. 5 is a response curve for the determination from a sample of diesel of total nitrogen and sulfur obtained with an OCECD analytical system which is contaminated with carbon residue with the catalytic combustion gas converter being inactive.

FIG. 6 is a response curve for the determination from a sample of diesel of total nitrogen and sulfur obtained with an OCECD analytical system which is contaminated with carbon residue with the catalytic combustion gas converter being active.

FIG. 7 is a graphic response of the nitrogen detector with and without the catalytic combustion gas converter being active.

FIG. 8 is a graphic response of the sulfur detector with and without the catalytic combustion gas converter being active.

### DETAILED DESCRIPTION OF THE INVENTION

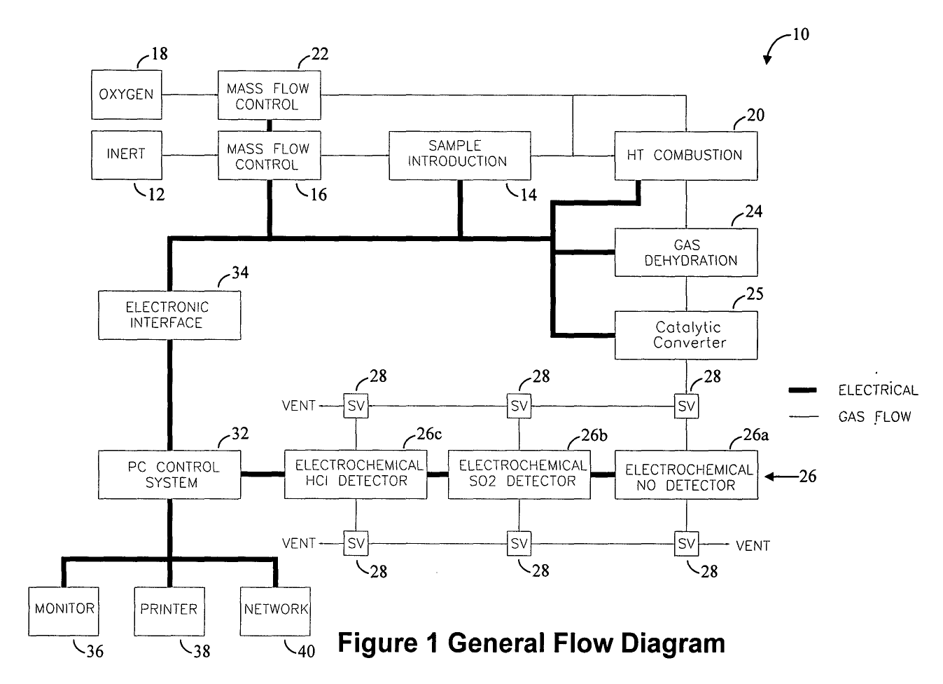

With reference to FIG. 1, an analytical system 10 for measuring total nitrogen, sulfur and/or chlorine in a sample is illustrated schematically according to the present invention. An inert carrier gas 12, such as high-purity argon, is fed to a sample introduction apparatus 14, and a mass flow controller 16 regulates the flow of carrier gas 12. Sample introduction apparatus 14 receives the sample for analysis, and the sample can be an aqueous or a hydrocarbon matrix and can be solid, liquid, gaseous or otherwise. Solid samples can be introduced by a quartz capsule or a quartz sample boat. Liquid samples can be introduced by microliter syringe, quartz capsule or quartz sample boat, and gaseous samples can be introduced by a gas sample valve or by a gas-tight syringe. The sample introduction apparatus must be suitable for the state of the sample and must be capable of delivering the sample accurately and repeatably.

Oxygen 18, which is preferably a high-purity oxygen, is mixed with the sample from sample introduction apparatus 14, and the mixture is fed to a high-temperature furnace module 20. Oxygen 18 is also fed directly to furnace module 20, and a mass flow controller 22 regulates the combined total flow of oxygen 18. Furnace module 20 includes a high-temperature tube furnace, which can be a quartz combustion tube capable of continuous operation in the range of about 900 to 1200° C. or a ceramic combustion tube capable of continuous operation up to at least about 1600° C. and preferably up to about 1800° C. The quartz combustion tube is packed with quartz chips, and a type K thermocouple or its equivalent is used for temperature measurement. A cooling fan is provided for removing excess heat from a housing for furnace module 20. A furnace suitable for use as furnace module 20 is available from APS Technologies, Inc. of Spring, Tex.

In furnace module 20 the sample is vaporized in the high-temperature oxygen-rich atmosphere, and the sample is oxidized. This oxidation of the sample and all of its constituents produces a combustion gas containing stable oxides, except for chlorine, which is unstable as an oxide. Chlorine reacts with water in the combustion gas to produce hydrogen chloride (hereinafter referred to as “HCl”), the water being produced as a by-product of combustion or introduced as part of the sample. Thus, chlorine in the sample is converted to HCl. Nitrogen in the sample, except diatomic nitrogen, N₂, is converted to nitric oxide (hereinafter referred to as “NO”), and sulfur in the sample is converted to sulfur dioxide (hereinafter referred to as “SO₂”). Nitrogen, sulfur and chlorine in the sample can exist as essentially any compound, and compounds containing the elements nitrogen, sulfur and chlorine in the sample are converted essentially completely to NO, SO₂ and HCl, respectively. Thus, measurement of these compounds provides a measurement of the total amount of these elements in the sample. For example, in a hydrocarbon matrix the nitrogen and sulfur may be bound to a hydrocarbon molecule, and the chlorine may be present as a chlorinated organic compound.

The combustion gas produced in furnace module 20 is dried in a gas dehydration unit 24 to remove water, producing a water-free or dry combustion gas sample. Water in the combustion gas may have been produced in furnace module 20 as an oxidation by-product or, for example, it may have been part of an aqueous sample. In either case it is preferable to remove the water. Gas dehydration unit 24 includes a permeation dryer such as that sold by Perma Pure, Inc. under the registered trademark Nafion, part number PD-624-12PP-APS or an equivalent dryer. Alternatively, a 98% sulfuric acid scrubber with a heated gas transfer tube can be used to remove water from the combustion gas, thus producing the water-free or dry combustion gas sample.

The dry combustion gas sample, also known as an analytical gas, from gas dehydration unit 24 is fed to a catalytic combustion gas converter system 25 which is comprised of an inert tube (either quartz, glass, or ceramic), a catalyst restraint (either quartz wool, glass wool, or ceramic wool), a catalyst capable of converting NO₂ and/or NOₓ to NO without reacting with or changing the ambient concentration of the SO₂ in the combustion gas stream, a heating mantle, a power source, and gas tubing fittings. When the OCECD analyzer is in use the catalyst is heated to 350° C. with a normal flow of analytical gas of 300 to 500 mL/min across the catalyst and thereafter the analytical gas is fed to a micro-electrochemical detector system 26. The catalyst of the catalytic combustion gas converter system 25 is preferably a bed of powered graphite.

Micro-electrochemical detector system 26 includes at least one electrochemical detector and as many as three. In this embodiment three electrochemical detectors are illustrated, an electrochemical NO detector 26a, an electrochemical SO₂ detector 26b and an electrochemical HCl detector 26c. Electrochemical NO detector 26a selectively detects NO, and other compounds or species in the dry combustion gas sample do not interfere with the measurement of NO in the sample. Electrochemical SO₂ detector 26b selectively detects SO₂, and other compounds or species in the dry combustion gas sample do not interfere with the measurement of SO₂ in the sample. Likewise, electrochemical HCl detector 26c selectively detects HCl, and other compounds or species in the dry combustion gas sample do not interfere with the measurement of HCl in the sample.

Suitable electrochemical detectors can be obtained from City Technology, Ltd. of Portsmouth, Hants, England. City Technology, Ltd. has a part number 3MNT or equivalent three or four electrode models suitable for use as electrochemical NO detector 26a, part number 3MST/F or equivalent three or four electrode models suitable for use as electrochemical SO₂ detector 26b, as well as one for electrochemical HCl detector 26c. Electrochemical detector system 26 has solenoid valves 28 for directing sample flow through electrochemical detectors 26a, 26b and 26c, which may be operated in parallel or in series, and if in series, then in any sequence since there is no interference in measurements. Vents 30 are provided for venting the sample from electrochemical detectors 26a, 26b and 26c. All of the electrochemical detectors 26a, 26b and 26c can be used in electrochemical detector system 26 or any one or two can be used. A particular application will dictate which of electrochemical detectors 26a, 26b and/or 26c to use.

A control system 32 provides a user interface, processing capability and electronics for operating, through an electronic interface 34, sample introduction apparatus 14, mass flow controllers 16, 22, furnace module 20, gas dehydration unit 24 and electrochemical detector system 26. Dark, heavy lines indicate electrical connection between components, while light, fine lines indicate the flow of sample, carrier gas 12 and/or oxygen 18. Control system 32 uses presently a personal computer, and a graphical interface is provided using software such as that provided by Microsoft corporation under the trademarks Windows 95 or Windows NT. A monitor 36, a keyboard and a pointing device, such as a mouse, provide an interface to control system 32 for a user. Control system 32 stores and displays data via monitor 36 or a printer 38, and control system 32 can be networked with other computers via a network system 40. Software, such as is used typically with such analyzer systems, is provided for control of the various components and for manipulation, display and analysis of data.

To operate analytical system 10, control system 32 is activated and furnace module 20 is heated to its operating temperature. Inert carrier gas 12, such as dry argon or helium with a minimum purity of 99.9%, and oxygen 18, with preferably a minimum purity of 99.7%, are available from pressurized sources and mass flow controllers 16 and 22, respectively, control flow of these gases through the system. Analytical system 10 is previously assembled with a proper array of electrochemical detectors 26a, 26b and/or 26c for the sample to be analyzed. Depending on the concentration and matrix, a 1 to 100 μL sample is fed to analytical system 10 via sample introduction apparatus 14 using a quartz boat, quartz capsule, syringe or valve as described above. For multiple samples, an automatic sampler can be used for feeding samples sequentially to the system.

Oxygen present in the high-temperature (900 to 1600° C., typically about 1000° C.) tube furnace provides a highly oxidative atmosphere for oxidizing the sample as it is carried through furnace module 20. If the sample contains nitrogen, sulfur and chlorine compounds, then combustion gas from furnace module 20 or gas dehydration unit 24 contains NO, SO₂ and HCl, respectively. The sample can contain all three, any one, or any two compounds containing nitrogen, sulfur and/or chlorine.

The general physical state of the analyzer can have an influence on the final result of the analysis. If a system is in sub-standard condition, poorly maintained, or poorly operated, the analytical results will be suspect. The analytical system must be clean, leak-free, and in a good state of repair. In the sulfur and nitrogen modes, the Oxidative Combustion/Electrochemical Detection (OCECD) analyzer may be subject to various reaction processes which could degrade the general performance, repeatability, and accuracy of analytical determinations. The primary cause of this degradation of performance is the accumulation of residue between the combustion tube of the high-temperature furnace module 20 and the electrochemical detector of the electrochemical detector system 26. This residue can take many forms. The most common forms of residue are: carbon residue, which may be deposited by the incomplete combustion of hydrocarbon materials; metal oxide residue, which may be deposited due to normal oxidation of metal-containing substances in the combustion furnace; and, other partially oxidized compounds, which may be deposited by the incomplete combustion of nearly any organic material. The accumulation of residue in the combustion gas flow system can provide a medium for unwanted chemical reactions to occur in the gas phase, thus altering the expected concentration of sulfur dioxide and/or nitric oxide. Carbon particles and other residue, which may accumulate in the analytical flow system, will absorb moisture, gaseous oxides, and hydrocarbon fractions. This scenario alone can provide favorable conditions for a wide variety of side reactions to occur in the gas stream, with completely random consequences. Since the electrochemical sulfur detector is designed to measure SO₂ in a gas stream of relatively predictable constituents, such a complex and unusual mixture of materials can cause unpredictable results. Some undesirable results may include quenching of the reactions of interest, side reactions in the detection mechanism, interruption of detector equilibrium, fluctuations in permeation devices, etc. If this situation is not addressed, erroneous data can be generated.

At the exit of the combustion furnace 20, the combustion gas stream contains approximately 80-100% oxygen, approximately 0-20% argon, and lesser quantities of CO₂, H₂O, SO₂, NO, and other oxides. Normally, the combustion furnace will quantitatively convert all sulfur and nitrogen species of the original sample material to sulfur dioxide (SO₂) and nitric oxide (NO), respectively. Due to the oxygen-rich environment, the possibility of further oxidation of the various constituents of the combustion gas stream is a possibility. It has been determined that the sulfur dioxide produced in the combustion furnace can be further oxidized to SO₃. It has been determined that the nitric oxide produced in the combustion furnace can be further oxidized to NO₂. This additional oxidation and the resultant oxides way seriously degrade and/or interfere with the performance of the sulfur and nitrogen electrochemical detectors.

In order to enhance the performance of the OCECD analytical system and preserve the predictable and quantitative oxidation of sulfur and nitrogen compounds to sulfur dioxide and nitric oxide, a catalytic combustion gas converter system 25 as described is installed between the gas dehydration unit 24 and the electrochemical detector system 26. This catalytic combustion gas converter system is comprised of an tube, a catalyst restraint, a catalyst, a heating mantle, a power source, and gas tubing fittings.

Many materials have been investigated to find a suitable catalyst which quantitatively converts NO₂ and/or NOₓ to NO without reacting with, or changing the ambient concentration of, the SO₂ in the combustion gas stream. The following is a listing of the materials investigated as such catalysts and a brief description of the results obtained:

| Catalyst | Physical Form | Result |
|---|---|---|
| Pure Nickel | 1 mm wire & | Poor conversion of NOₓ to NO and strong |
| | 2 mm pellets | adsorption of SO₂ |
| Pure Nickel on | 2 mm spheres | Poor conversion of NOₓ to NO and strong |
| Ceramic | | adsorption of SO₂ |
| Substrate | | |
| Hastalloy | 1 mm wire | Nearly no conversion of NOₓ to NO and complete |
| | | adsorption of SO₂ |
| Pure Platinum | 0.5 mm wire | Poor conversion of NOₓ to NO and mild |
| | | adsorption of SO₂ |
| Pure Platinum on | 2 mm spheres | Poor conversion of NOₓ to NO and mild |
| Ceramic | | adsorption of SO₂ |
| Substrate | | |
| Graphite Rod | 3.05 mm | Moderate conversion of NOₓ to NO and mild |
| | diameter | adsorption of SO₂ |
| | 99.9995% | |
| Graphite Felt | 11.2 mm thick | Moderate conversion of NOₓ to NO and strong |
| | 99.9% | adsorption of SO₂ |
| Graphite Tape | 25 mm wide | Good conversion of NOₓ to NO and no adsorption |
| | 99.9% | of SO₂. Unpredictable response with slight |
| | | variations in temperature, gas flow and different |
| | | lots of tape. |
| Graphite Powder | 20-84 mesh | Excellent conversion of NOₓ to NO and no |
| Alfa Aesar Item | 99.9% | adsorption of SO₂. Completely reproducible |
| #10131 | | response with slight variations in temperature, gas |
| | | flow, and different lots of powder. |

Based on the experimental data obtained, the catalyst of choice for the catalytic combustion gas converter graphite, and preferable graphite powder such as Alfa Aesar Item #10131 graphite powder, available from Alfa Aesar which is a Johnson Matthey Company. However, suitability studies are ongoing for other possible catalytic materials.

In operation of the analyzer the catalyst bed of graphite powder in the catalytic combustion gas converter is heated to 350° C. and an analytical gas flows through the catalyst at a rate of 300 to 500 mL/min. The catalytic combustion gas converter system requires no special operating conditions for reliable performance. Normal operating gas flows and gas composition are acceptable for the basic function. Operating temperatures of 300° C. to 400° C. are adequate for quantitative conversion of the various oxides to the desirable species.

Expected reactions of combustion gas constituents within the catalytic combustion gas converter system include:

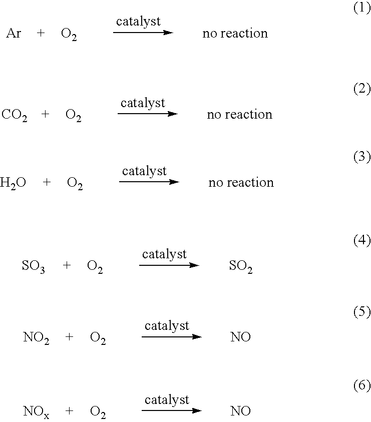

Reactions (1) thru (3) are not of interest. Reaction (4) is of modest interest since the formation of SO₃ is negligible. Experimentation has indicated that the primary reactions of interest are reaction (5) and (6). In a favorable environment, nitric oxide can be easily converted to NO₂ or other NOₓ compounds. These various NOₓ compounds will not be detected by the nitrogen electrochemical detector and may also have an adverse effect on the sulfur electrochemical detector.

Electrochemical detectors 26a and 26b yield a signal proportional to the concentration of NO and SO₂ respectively, in the gas sample coming from the catalytic combustion gas converter system 25, which, by calculation, is used to determine the total nitrogen, sulfur and/or chlorine in the sample. Such determination can be viewed on monitor 36, printed on printer 38 or transferred to another computer via network 40.

Chemiluminescent and fluorescent detectors became the standard or typical detector of choice for measuring total nitrogen and sulfur, respectively. Electrochemical analysis was dismissed as an unsatisfactory solution, and this view continued to exist until subsequent experimentation resulted in the OCECD analyzer. Consider the data in Table 1, which is representative data obtained for the analysis of nitrogen in a hydrocarbon matrix by combustion/chemiluminescence and by oxidative combustion/electrochemical detection (OCECD) even without the use of an catalytic combustion gas converter system.

| DETECTOR | Chemiluminescence | Electrochemical |
|---|---|---|
| PARAMETER | Nitrogen | Nitrogen |
| CONCENTRATION, mg/L | 5.0 | 5.0 |
| INTEGRATOR COUNTS | 109,658 | 153,463 |
| STANDARD DEVIATION | 7,519 | 4,517 |
| (counts) | | |

The electrochemical detector had a higher sensitivity (153,463 vs. 109,658 counts) for measuring nitrogen in the sample than did the chemiluminescence detector. Further, the electrochemical detector had a better repeatability (as indicated by the standard deviation of 4,517 vs. 7,519 counts) than did the chemiluminescence detector. This was also an unexpected result. It was discovered that the signal-to-noise ratio for analytical system 10 is significantly better than that for a prior art system using chemiluminescence and fluorescent detectors, both the sensitivity being greater and the noise being less. A signal-to-noise ratio for a prior art system using chemiluminescence and fluorescent detectors is commonly accepted as 2 to 1, but the signal-to-noise ratio for analytical system 10 is significantly better at 10 to 1 or greater. The detectable quantity of nitrogen, sulfur or chlorine in a sample using analytical system 10 is less than about 1 part per million by weight or 1 mg/kg.

An OCECD analytical system was purposely contaminated with carbon residue produced by incomplete combustion of toluene and diesel fuel. The system was then tested with various types of solvents and fuels to determine the influence on the electrochemical detection of sulfur and nitrogen. Some of the representative data, with and without the catalytic combustion gas converter, is discussed below.

Initially, a synthetic test sample was gravimetrically constructed with a relatively high concentration of nitrogen and a low concentration of sulfur. This sample is used to examine the influence which a contaminated flow system can have on the final analytical results. The methanol test sample contained approximately 100 ppm nitrogen, as carbazole, and 0 ppm sulfur. FIG. 2 contains the graphical representation of the detector signal. The first injection (left hand peaks) represents the signal with the converter active. The signal for both nitrogen (black line) and sulfur (white line) are expected and predictable. The second injection (right hand peaks) represents the signal with the converter inactive. Note that the nitrogen signal is greatly reduced and the sulfur signal is dramatically negative when the converter 25 is deactivated.

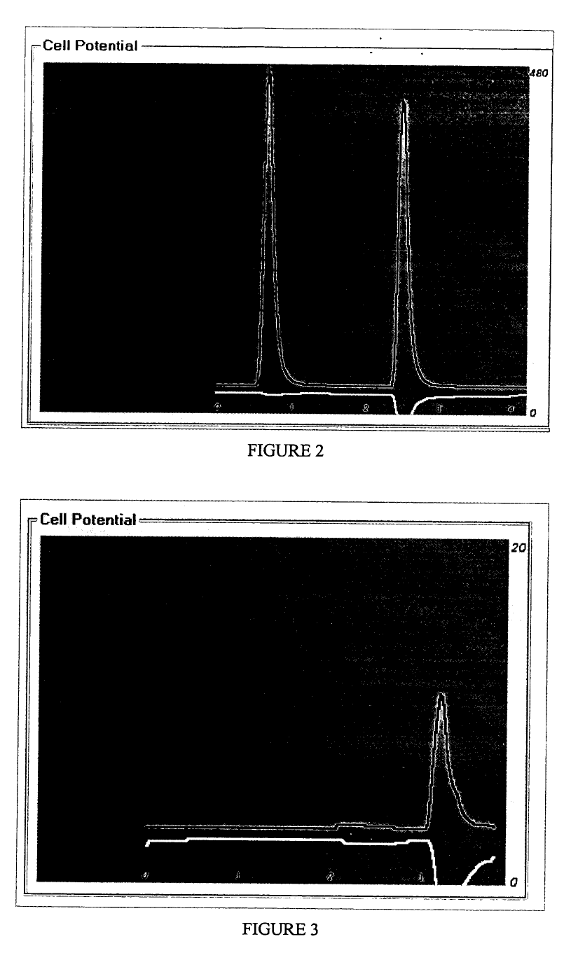

A water test sample, containing approximately 10 ppm nitrogen (as pyridine) and 10 ppm sulfur (as DMSO) was constructed and analyzed under the same conditions. FIG. 3 contains the graphical representation of the detector signal with the converter inactive. Note the relative size of the nitrogen signal (black line) and a nearly complete reversal of the sulfur response (white line). FIG. 4 is the same material which is analyzed with the converter 25 active. With the converter 25 active nitrogen response is noticeably larger and the sulfur response is normal. With the converter 25 active the signal for both nitrogen and sulfur are expected and predictable.

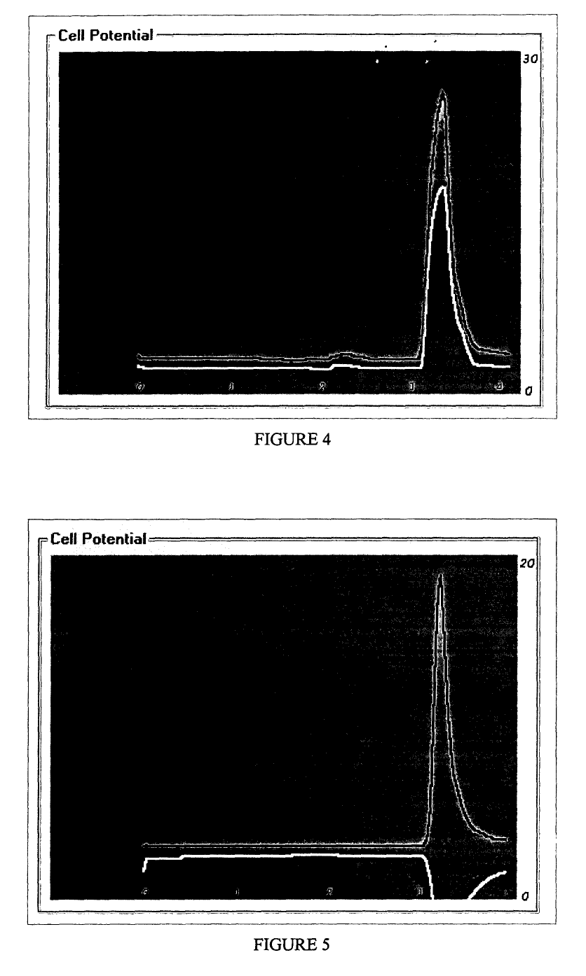

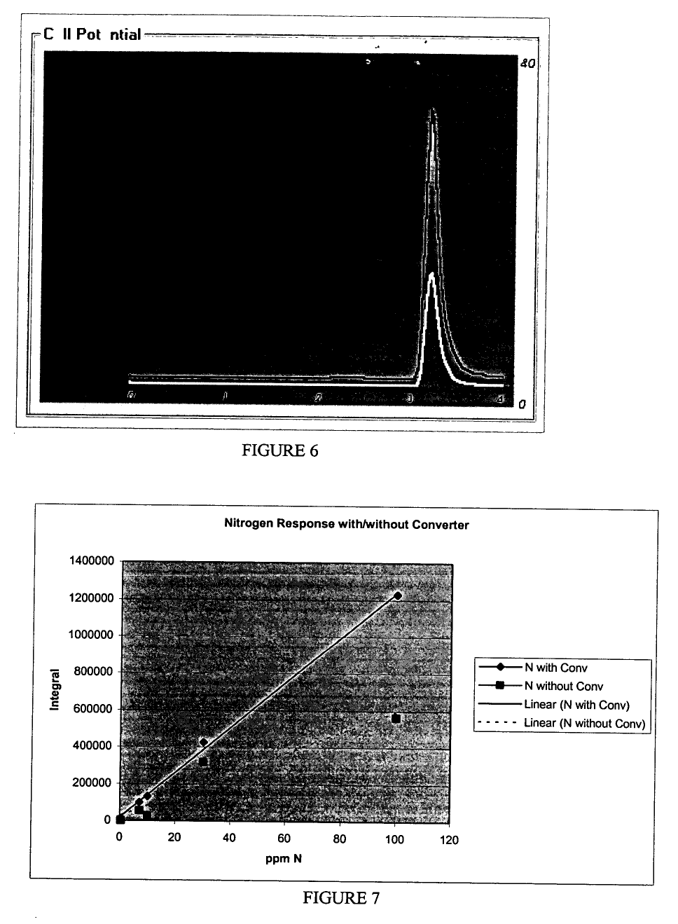

A diesel test sample, containing approximately 7 ppm nitrogen and 3 ppm sulfur was analyzed under the same conditions. FIG. 5 contains the graphical representation of the detector signal with the converter inactive. Again note the nearly complete reversal of the sulfur response. FIG. 6 is the same material which is analyzed with the converter 25 active. With the converter 25 active the signal for both nitrogen (black line) and sulfur (white line) are expected and predictable.

Some representative data is given the in Table 2 below. Inspection of this data clearly indicates the influence of a contaminated flow system between the furnace module 20 and the micro-electrochemical detector system 26 on the nitrogen and sulfur response. Great reduction in integrator response is noted in every instance, if the converter 25 is inactive.

TABLE 2

| | | | | | 100 ppm N/ |
|---|---|---|---|---|---|
| | E | 11 | 10 ppm N/S | B | 0 ppm S |
| Sample | isooctane | Diesel | Water | isooctane | MeOH |
| ˜N conc | 0.3 | 7 | 10 | 30 | 100 |
| N response with converter | 4263 | 99532 | 132640 | 424690 | 1230700 |
| N response without converter | 1977 | 55570 | 28815 | 317785 | 562762 |
| ˜S conc | 0.3 | 3 | 10 | 35 | 0 |
| S response with converter | 3622 | 43047 | 141319 | 511887 | 0 |
| S response without converter | 0 | 0 | 0 | 322554 | 0 |

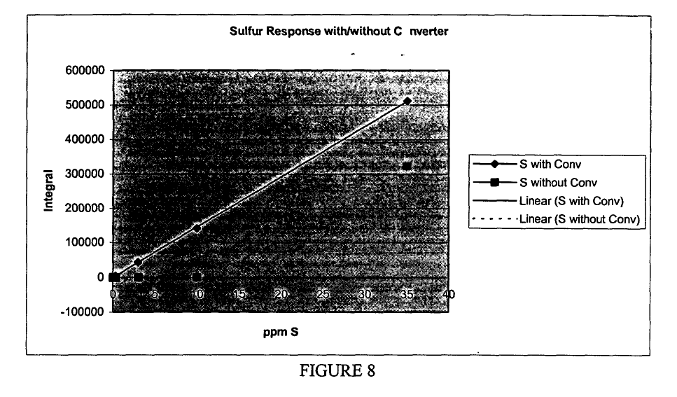

Plots of the raw integrator response versus the concentration for both nitrogen and sulfur are given below. The sulfur response is reported as zero since the intergrator does not operate on negative peaks. FIG. 7 illustrates the response of the nitrogen detector and FIG. 8 gives the response of the sulfur detector. In all cases, nitrogen content in the sample has an adverse effect when the flow system is contaminated and the converter is not used.

The American Society for Testing and Materials (ASTM) develops voluntary consensus standards and provides related technical information and services. ASTM standards are generally recognized in at least the United States and in some cases their standards are recognized internationally. ASTM developed two new standards for analysis according to the present invention because no existing standard was suitable for this analysis. For measurement of total nitrogen according to the present invention, ASTM designation D6366-99 was developed. Entitled “Standard Test Method for Total Trace Nitrogen and its Derivatives in Liquid Aromatic Hydrocarbons by Oxidative Combustion and Electrochemical Detection,” ASTM standard D6366-99 is incorporated by reference in its entirety. ASTM test method D6366-99 states that this test method covers the determination of total trace nitrogen, whether organic or inorganic, found in liquid aromatic hydrocarbons, such as petroleum oils, its derivatives and related chemicals. Suitable samples may contain nitrogen ranging from 0.05 to 100 mgN/kg, and the detector response is linear with nitrogen concentration.

ASTM D6366-99 states as a summary of the test method that a sample of liquid aromatic hydrocarbon is controllably injected into a stream of inert gas such as helium or argon. The sample is vaporized and introduced to a pyrolysis furnace operating at >900° C. Oxygen is mixed with the sample, and organic and inorganic nitrogen compounds are converted to nitric oxide. Nitric oxide is reacted with a sensing electrode in a 3-electrode electrochemical cell, and this reaction produces a measurable current that is directly proportional to the amount of nitrogen in the original sample. Moisture that is produced as a product of combustion should be removed before passing to the electrochemical detector as otherwise it may interfere with the measurement. The apparatus required is as described herein.

Sample integrity should be preserved and care should be taken to prevent the loss of volatile components within a liquid sample. As this procedure is capable of determining trace levels of nitrogen, the sample container and the method of handling the sample should be such as to not introduce nitrogen into the sample. The analytical system can be calibrated by preparing a series of calibration standards with a stock solution for the range of measurements anticipated. For a liquid sample, a syringe can be used to inject the sample, and the syringe itself can be used for volumetric measurement. The sample may also be weighed taking into account a tare for the syringe. A typical range for a liquid sample size is from about 3 to about 40 μL.

The analyzer system is generally provided with an automatic calibration procedure, but if not, a standard curve can be constructed by using a calibration standard to construct a curve plotting milligrams of nitrogen injected versus detector response as measured in an integration count. The response curve should be linear and should be checked from time to time.

Even without use of the catalytic combustion gas converter system as herein described, as to precision, tests have indicated that for a sample containing nitrogen at a level of 1.00 mg/kg, the amount of nitrogen can be measured within a deviation of 0.02 mg/kg using ASTM D6366-99 and apparatus and method according to the present invention. The utilization of the catalytic combustion gas converter system will further improve the performance of Oxidative Combustion and Electrochemical Detection for the total determination of Nitrogen by converting any unintended NO₂ and/or NOₓ back into NO.

ASTM D6428-99 was developed for determining total sulfur in liquid aromatic hydrocarbons, derivatives thereof and related chemicals according to the present invention. ASTM D6428-99 is incorporated by a reference and is entitled “Test Method for Total Sulfur in Liquid Aromatic Hydrocarbons and their derivatives by Oxidative Combustion and Electrochemical Detection.”

Samples containing sulfur ranging from about 0.05 to about 100 mgS/kg are suitable for measurement using this method, which provides a linear measurement proportional to sulfur concentration. The procedure is much like that for determining nitrogen in ASTM D6366-99. A sample of liquid aromatic hydrocarbon containing sulfur in the range of 0.05 to 100 mgS/kg is controllably injected into a carrier gas of helium or argon. The sample is vaporized and heated to over 900° C. Oxygen is mixed with the vaporized and heated sample, and sulfur compounds in the sample are converted to sulfur dioxide. Sulfur dioxide is reacted with a sensing electrode in a 3-electrode electrochemical detector cell, where a measurable current is produced that is linearly proportional to the amount of sulfur in the sample.

As to precision, tests have indicated that for a sample containing sulfur at a level of 1.01 mgS/kg, the amount of sulfur can be measured within a deviation of 0.02 mgS/kg using ASTM D6428-99 and apparatus and method according to the present invention. An absolute standard deviation of 2.76 mg/kg was obtained at a sulfur level of 80.0 mg/kg. The utilization of the catalytic combustion gas converter system will further improve the performance Oxidative Combustion and Electrochemical Detection for the total determination of sulfur by converting any unintended NO₂ and/or NOₓ which interferes with sulfur detection back into NO which is non-interfering with sulfur detection.

The American Society for Testing and Materials did not have a standard for measuring total nitrogen or total sulfur using an electrochemical detector and the apparatus and method of the present invention. Upon initiation by the present inventors, designations D6366-99 and D6428-99 were developed by ASTM to set forth a standard procedure for using apparatus according to the present invention. ASTM designations D6366-99 and D6428-99 provide accurate, reliable and repeatable analytical methods for measuring total nitrogen and total sulfur, respectively. The employment of a combustion gas converter will only enhance the accuracy, reliability and repeatability of the OCECD analytical methods for measuring total nitrogen and total sulfur, respectively.

The foregoing disclosure and description of the invention are illustrative and explanatory thereof, and various modifications and alterations to the embodiments disclosed herein will be apparent to those skilled in the art in view of this disclosure. It is intended that all such variations sand modifications fall within the spirit and scope of this invention as claimed.

We claim:

1. An analytical system for measuring total nitrogen and/or total sulfur in a sample, comprising:
a furnace system for oxidizing the sample, the furnace system having an inlet and an outlet and producing a combustion gas stream containing nitric oxide (NO) and/or sulfur dioxide (SO₂), the furnace system being capable of operating at about 900° C. or higher;
a sample introduction apparatus for delivering the sample to the inlet of the furnace system;
an electronic mass flow controller to regulate flow from a source of high-purity oxygen, the oxygen being provided for oxidizing the sample;
an electronic mass flow controller to regulate flow from a source of carrier gas into the furnace system;
a dehydration unit in fluid communication with the outlet of the furnace system for removing water from the combustion gas stream;
a catalytic combustion gas converter system in fluid communication with the dehydration unit, comprised of an inert tube containing a graphite catalyst capable of converting NO₂ and/or NOₓ to NO without changing the ambient concentration of the SO₂ in the combustion gas stream, a heating mantle, a power source, and gas tubing fittings, the catalyst being heatable to between 300° C. to 400° C. when receiving a gas flows of 300 to 500 mL/min from said dehydration unit, a first electrochemical detector having an electrolyte, a sensing electrode, a counter electrode and a reference electrode, the electrochemical detector being sealed in a container and having a membrane for receiving a portion of the combustion gas stream from the dehydration unit, wherein electrochemical detector is adapted for selectively detecting NO or SO₂ in the combustion gas stream.

2. The analytical system of claim 1, further comprising a computer control system coupled to the furnace system, the sample introduction apparatus, the mass flow controllers for oxygen and carrier gas, and the detector for providing supervisory control, monitoring, data storage and analysis, computer control system being capable of providing control for the furnace system, the sample introduction apparatus, the mass flow controllers and the detector.

3. The analytical system of claim 1, further comprising a second electrochemical detector operated in series with the first electrochemical detector, wherein a chemical compound measured by the second electrochemical detector does not interfere with the first electrochemical detector.

4. The analytical system of claim 2, wherein the system is adapted for measuring total nitrogen and total sulfur in a liquid hydrocarbon sample.

5. The analytical system of claim 1, wherein the catalyst is graphite.

6. The analytical system of claim 1, wherein the catalyst is graphite powder.

7. The analytical system of claim 1, wherein the detector detects nitric oxide (NO), further comprising a detector for detecting sulfur dioxide (SO₂), wherein the detectors are capable of operation in series.

9. The analytical system of claim 1, wherein the detector detects nitric oxide (NO), and wherein the analytical system is capable of determining total nitrogen according to ASTM designation D6366-99.

10. The analytical system of claim 9, further comprising a detector for detecting sulfur dioxide (SO₂), wherein the analytical system is capable of determining total sulfur according to ASTM designation D6428-99.

11. The analytical system of claim 10, wherein the detectors are capable of operation in series.

12. An analytical system for measuring total nitrogen and total sulfur in a liquid hydrocarbon sample, comprising:
a furnace system capable of operating at about 900° C. or higher to receive and oxidize the sample, the furnace system having an inlet and an outlet and capable of producing a combustion gas stream containing nitric oxide (NO) and/or sulfur dioxide (SO₂);
a sample introduction apparatus for delivering the sample to the furnace system;
a first mass flow controller for regulating flow of a carrier gas to the sample introduction apparatus;
a second mass flow controller for regulating flow of oxygen to the inlet of the furnace system;
a dehydration unit in fluid communication with the outlet of the furnace system for removing water from the combustion gas stream;
a catalytic combustion gas converter system in fluid communication with the outlet of the dehydration unit, comprised of an inert tube containing a bed of graphite catalyst, a heating mantle, a power source, and gas tubing fittings, the bed of graphite catalyst being heatable to between 300° C. to 400° C. when receiving a gas flows of 300 to 500 mL/min from said dehydration unit, at least two electrochemical detectors adapted to operate in series, each electrochemical detector having an electrolyte, a sensing electrode, a counter electrode and a reference electrode, the electrochemical detector being sealed in a container and having a membrane for receiving a portion of the combustion gas stream from the dehydration unit, said at least two electrochemical detectors selectively detecting NO and SO₂ in the combustion gas stream; and
a control system coupled to the furnace system, the sample introduction apparatus and each electrochemical detector for providing supervisory control, monitoring, data storage and analysis.

13. A method capable of determining total nitrogen and/or total sulfur in a liquid sample, the method comprising the steps of:
providing a pyrolysis furnace capable of vaporizing the sample;
providing a sample introduction system for introducing the sample to the furnace;
providing a quartz combustion tube capable of operating at 900° C., the combustion tube being adapted for combusting the sample;
producing a combustion gas as an exhaust from the combustion tube;
drying the combustion gas to form a dry sample gas;
passing the dry gas sample over a graphite catalyst heated to a temperature of 300° C. to 400° C.,
detecting a compound in the dry sample gas which has passed over said graphite catalyst using an electrochemical detector having at least three electrodes; and
determining total nitrogen and total sulfur based on measurement of the detected compound.

15. The method of claim 14, wherein at least two detectors are operated in series.

16. The method of claim 13, wherein total nitrogen is determined in conformance a standard set forth by the American Society for Testing and Materials (ASTM) in nation D6366-99.

17. The method of claim 16, wherein total sulfur is determined in conformance standard set forth in ASTM designation D6428-99.
